(19) United States
(12) Patent Application Publication
(10) Pub. No.: US 2003/0021907 A1
(43) Pub. Date: Jan. 30, 2003

(54) Bottom coating of beverage cans

(76) Inventors: Fred Franken, Remagen (DE); Martin Offermann, Bonn (DE)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/182,681

(22) PCT Filed: Feb. 2, 2001
(86) PCT No.: PCT/EP01/01140

(30) Foreign Application Priority Data
Feb. 2, 2000 (DE) 100 04 403.4

(51) Int. Cl. B05C 5/00

(52) U.S. Cl. 427/425; 118/320

(57) ABSTRACT

The object of the invention is to provide a method with which smallest possible quantities of a varnish coating a bottom of a can extend beyond a bottom area (30a,30b), into a wall portion (30c) provided with a decoration, in order to reduce the quantity of coating substance used and to prevent said decoration from being changed. The invention proposes a coating with a fluid coating substance, each can (30) having a can axis (102). Said cans (30) are supplied consecutively out of an inlet (4), for being supported on a supporting means (3) for at least a coating interval and for being rotated about at least one axis (100,101,102). A spraying head (15,15a) having a spraying axis (104) sprays a coating onto an outer portion (30a) of said bottom area of at least one of said supplied cans (30), said spraying being effected at a first angle (α) of said spraying axis with respect to said can axis (102). Said coating is sprayed onto a portion (30b) of said bottom area, said portion being located further radially inside, said spraying being effected at a second angle (β) with respect to said can axis, said second angle (β) differing from said first angle (α).

The invention relates to a method for coating a bottom area of at least one can, particularly of a plurality of supplied cans, which, after having been supplied, are rotated about at least one axis and which, while being rotated—during at least a time interval of said rotation—are coated with a fluid coating, particularly with a varnish containing a coloring substance. The invention further relates to an arrangement according to claim 27 for carrying out the methods according to one of claims 1 and 10.

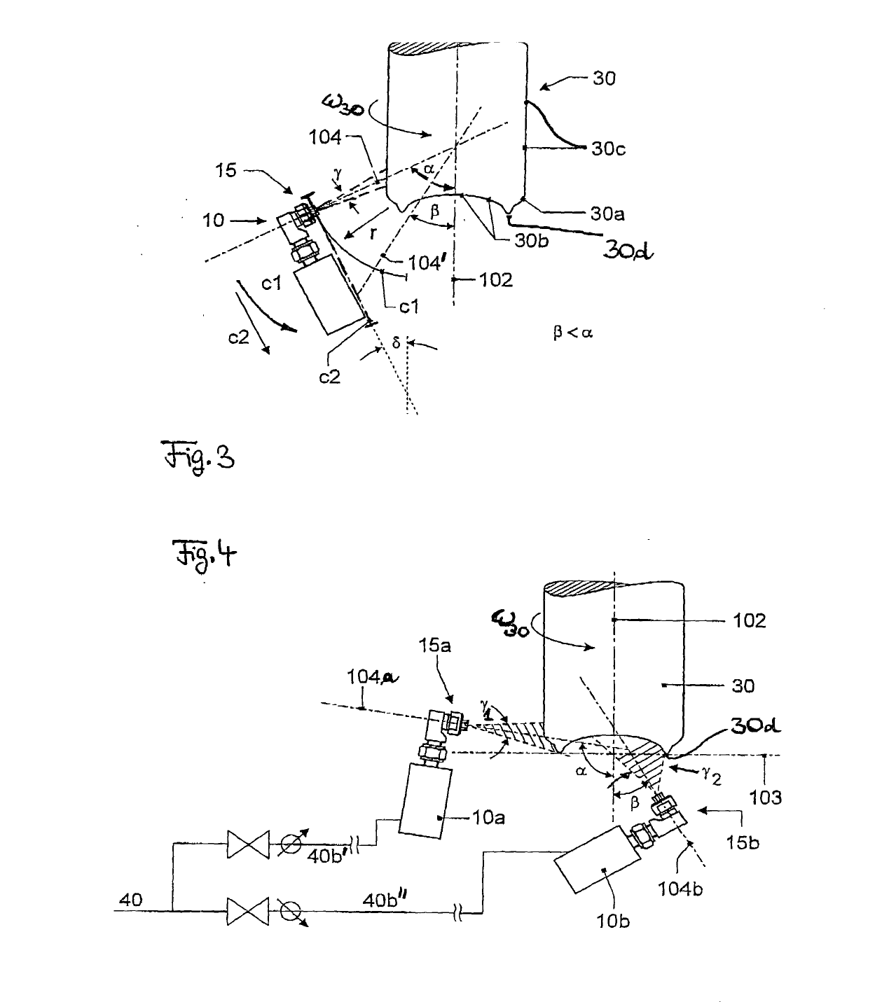

Those skilled in the art know from a not directly related technical field, compare DE-A 39 43 371 (Gut Springenheide), to color and decorate egg-shaped objects having oval form by using several spraying heads. The eggs are rotated by two shafts on a three-point bearing, and the color beams can be altered in their orientation with respect to said rotating egg (compare claims 1 to 3 of said publication). During a coating interval, said prior art egg-shaped objects are supported and rotated about an axis. During coating, said objects are spray-coated by a spraying head at a first angle onto an outer portion, and a coating is applied onto a further radially inward portion at a second angle with respect to the axis of said egg-shaped object, said second angle differing from said first angle (compare FIG. 2 of said publication). With regard to an arrangement also described in said document, a spraying unit is provided, said spraying unit comprising a spraying head which is inclined with respect to the axis of said egg-shaped object, also compare FIG. 2, and column 3, lines 26 to 50. During spraying, the position and the axis of said spraying unit are changeable over a path, compare column 3, lines 51 to 61, and column 4, lines 11 to 20, with regard to a cross-rail 14 described therein and a rod oriented in a longitudinal direction, at which rod said cross-rail being located and synchronously moved with a drive not illustrated there, compare column 4, lines 57 to 65 of said document. Moreover, the spraying arrangements located on said cross-rail are two spraying units, the positions and the spraying axes of which are not changeable and which are attributed to the same egg-shaped object such that the two axes are not coincident, but are oriented each towards a defined band-shaped or ring-shaped portion of said egg-shaped object.

Beverage cans (thin-wall tin cans) are currently coated at different surface portions thereof using different methods. An inside coating along a wall, an inside coating along a bottom, and an outside coating along a wall and along a bottom are known. Said outside coating along a wall is characterized by a decoration being applied onto said beverage can together with said outside coating, whereas said bottom area usually being coated with a colorless varnish. Said bottom area comprises “dome, rim and chime” portions, i.e. an inner bottom portion vaulted towards the inside, an annular edge portion on which the can stands, and a short lower portion of said outer can wall. Said portions shall be designated as bottom area, although comprising a part of said wall portion. For coating said bottom area, a nozzle usually applying a flat beam of a varnish is aligned such that it is oriented along a defined axis with respect to a can axis. For this purpose, said spraying axis can be adjusted in three directions, but during coating, i.e. during a spraying process, it will only spray a coating onto the bottom area of a can in one single axial direction, while the can effects a relative movement with respect to the spraying angle or the center axis of said spraying angle as a spraying axis, respectively. The can effects multiple rotations about its own axis. During at least two to three rotations, a spraying beam is activated, so that a multi-layer varnish coats said bottom. The spraying time is controlled and adjusted such that said coating always ends at an identical position, even when the rotary movement of the can is different. For realizing such a spray-coating, the cans are supplied individually and positioned at a circumferential distance on a supporting wheel (supporting means) which rotates slowly, and wherein each can itself, at its circumferential position, rotates about a can axis at a higher speed. The nozzles, which have fixed axes co-rotate with said rotary movement of said supporting means, so that bottom coating can be effected during said double rotary movement. After finishing said coating, the cans are removed from said supporting means. After said bottom coating, said bottom area is covered with a uniform varnish layer as an anticorrosive, said varnish layer usually being colorless.

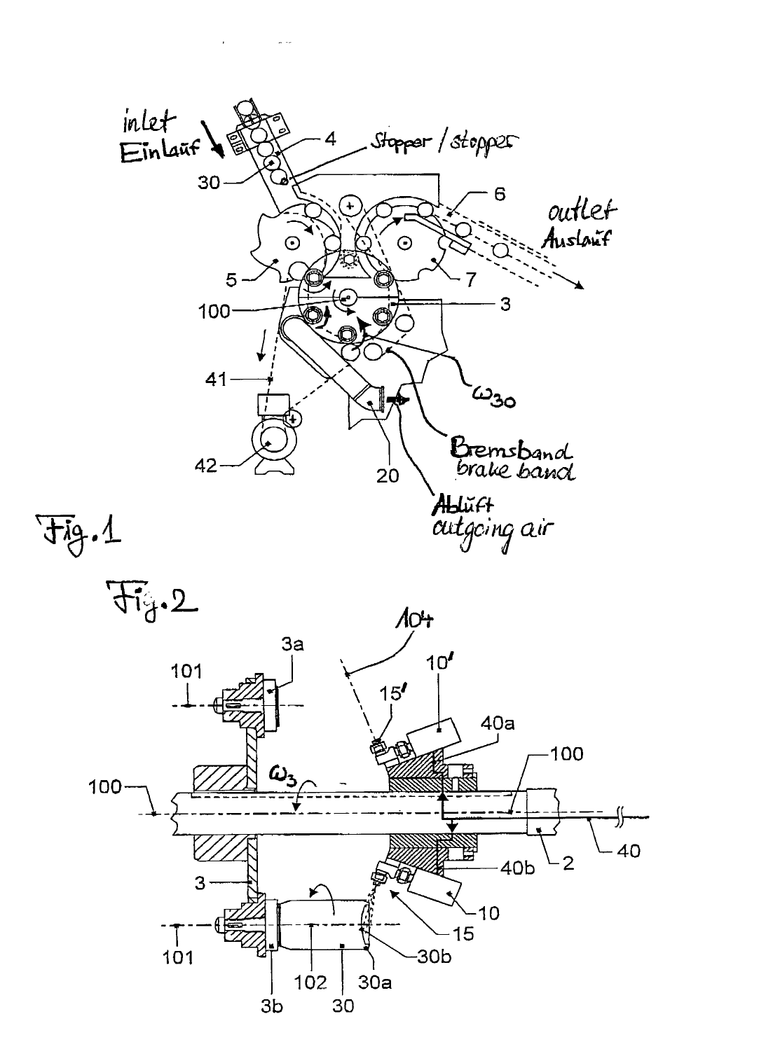

The publications GB 1 504 337 or DE-A 25 20 741 (Toyo Ink) describe a coating of an outer surface of glass bottles. A bottle is rotated and covered with a band-shaped stripe of a coating substance at a speed of 60 or 30 r.p.m. Said band-shaped stripe is applied as a helical, mutually overlapping band, one spraying nozzle being turned through an angle in a direction towards said bottom surface when reaching said bottom area, for also being able to coat a bottom area of said bottle, compare FIG. 1, page 3, lines 58-63 and claim 6.

An object of the invention is to provide a method with which also a colored varnish can be applied onto a bottom area of cans, by which method a smallest possible quantity of color portions of said varnish up to no color at all extends beyond said bottom portion and into the wall portion of said cans, where a decoration is positioned. Since coating a bottom area usually is the last working cycle of an outside coating process of an entire can, an optical decoration of the outer wall of a can would be affected by spray particles of said bottom varnish extending into said portion. This is particularly valid for colored spray particles, but also for colorless spray caoting which is also visible in an optical decoration of an outer wall when extending beyond a bottom area during application.

Said object is solved according to one of claims 1 and 10. An arrangement for carrying out said methods is specified in claim 27.

According to the invention, it is avoided that a coating determined for a bottom extends beyond a bottom area during application. In this respect, cans supplied out of an inlet are rotated about at least one axis, preferably about two axes which are offset with respect to each other, during a coating time interval, and coated by a spraying head such that a spraying axis determining said coating adopts not only a first angle with respect to a can axis, but at least one additional angle, said additional angle differing from said first angle (claim 1, claim 10). By accordingly adjusting said spraying axis (center axis of a spraying angle), a coating from at least two different directions is realized (claim 10).

Said two directions define to spraying axes (claim 3, 4, 7 and claims 12 to 14 which are described below). In both, a guided path according to claim 4 and two separate spraying heads having two independent spraying axes according to claim 2, at least two directions of angle are provided for defining limit or end positions. Both end positions are oriented such that a fluid coating does not extend into a wall portion, so that in accordance with the invention, only a bottom area is to be and is coated. Said wall portion comprising a decoration is left free from said coating. An advantageous consequence of the inventive method, besides a preservation of the decoration, is a reduction of the coating substance used, namely in a quantity corresponding to that which has so far extended into the decorated portion. Said two end angles define the precondition that with none of said angles, particularly not with the angle, which as a spraying direction is responsible for the coating of an outer portion of a bottom area, substantial particles of said fluid coating substance reach into said decorated portion. Preferably, a spraying direction from above a contact plane is selected (claim 3), wherein an angle larger than zero is referred to said contact plane of said can, said angle being lager than 90° in absolute value with respect to said can axis. With respect to said can axis, said angle is to be measured such that it is oriented in a mathematically negative sense (thus clockwise), which actually defines an angle of −90°, thus requiring an angle smaller than −90° for a spraying direction from above said contact plane (compare claim 31 with reference to apparatus claim 27).

Several technical orientations are described as at least two directions (one of claims 12, 13 and 14). For one thing, a different direction is understood as a direction substantially offset in parallel with respect to a can axis (claim 12). Another direction is also understood as another inclination of a spraying axis (claim 13). A combination of said two other directions is understood as a change of an axial position of a spraying head in combination with a change of inclination (claim 12, 13).

A change of a radial position of the starting position of a spray beam is also understood as another direction (claim 14). In this case, the direction of the moved coating particles when contacting said bottom area is changed. Said other direction can preferably be combined with one or several of the aforementioned other directions.

When using a guided path (claim 1, 15), said spraying head changes its relative position with respect to said bottom area and with respect to an axis of a can to be coated, respectively, while said can rotates about a can axis thereof, so that a coating is applied rotationally symmetrically with respect thereto. Said guided path can be provided such that the direction, particularly the direction of the axis of the spraying head during coating is continuously changed at least during a time interval of coating(claim 16). In case of such a change, said curved path can effect a substantially circular-arc movement with respect an the outer (lower) edge of a can, at least along a portion of said curved path, so that said spraying head moves at least along such a circular arc portion (claim 17, 18). Additionally, a straight displacement portion can be provided, effecting both, an axial and a radial change of the spraying head, each of said changes being in relation to the can axis about which the can rotates during coating.

Not only one changing spraying axis can be used, but also two spraying heads can be provided (claim 2), said spraying heads coating a bottom area of a can from two different directions, particularly two angle orientations, while said can rotates. Said spraying axes can be located on two different planes, intersecting at said can axis.

In order to specify the individual portions of a bottom area, it is to be mentioned that said bottom area comprises an inner portion and an outer portion. Said inner portion is substantially constituted by a dome-shaped extension of a can bottom of a beverage can. Said outer portion comprises both, a contact surface of said can, and a part of a lower wall portion of said can. By guiding said spraying axis of a moving spraying head or by providing two spraying heads having a spraying axis including an angle larger than 90° with said can axis especially in said portion, it is achieved that a general direction of said coating extends such that it is not oriented towards a remaining wall portion, thus no angle positions being present urging coating substances in a direction of an upper wall portion of a can, said portion having already been provided with a decoration. By said method, it is safely avoided that coating substances reach into said portion and affect or damage a decoration in an optically visible manner.

The two angles of two spraying heads or the limit angles of one single moving spraying head can be defined according to claim 3.

When providing one single spraying head and a guided path, initially, an inner portion and subsequently, an outer portion can be coated or vice versa (claim 5).

When using a circular arc as at least one portion of said guided path, both, an axial position and a distance of said spraying head from a center axis of a can (can axis) and from a point, respectively, said point being the piercing point of the can axis in a dome-shaped bottom portion, change. When using one spraying head, the two end positions are different from those set when using two separate spraying heads which are positioned at a distance of each other (claim 2). Each of said separate spraying heads is individually immobile with respect to the can axis; each of them remains fixedly set during coating. By a rotation of a can, a coating is effected in two radially spaced portions, said two spraying heads operating alternately or at least offset in time, for managing with one single main supply means of varnish as a coating substance (claim 24).

When using additional flow recognition means, blockages (times of a reduced flow through a respective spraying head can be detected (claim 25) when both spraying heads operate simultaneously during a time interval. One flow detection means, respectively, is attributed to each spraying arrangement in the form of a measuring arrangement (pressure and/or flow), for measuring a respective flow. When both spraying heads are active during at least a time interval of coating, it can only be determined on the basis of each individual flow measurement, whether both spraying heads operate regularly. When said spraying heads operate at different times, thus no overlap occurs during coating, e.g. said spraying heads alternate with each other in coating, a reduced flow can also be detected using only one single flow detection means in the main supply.

When using two spraying heads, each having individual fixed angles, a (possibly projected) intermediate angle being larger than 90° (claim 8, 19), a guided path is not required and the same main varnish supply can initially supply one spraying head and then the second spraying head through one inlet. Preferably both separate spraying heads can have different spraying angles (with respect to the can axis), they also can have different spraying axes. For instance, an outer edge portion of a bottom area can be coated with a smaller spraying angle (claim 20, 21), said portion being sprayed (in a downward direction) from an angle larger than 90° in absolute value with respect to the axis, so that an upper edge portion remains free from spray particles of said coating. An inner bottom portion is coated with a separate spraying head, said spraying head being oriented at an angle smaller than 90° in absolute value with respect to the axis of the can, but has a spraying cone or angle larger than said angle coating said outer portion of said bottom area. Using said coating method, the risk that particles leave said usually dome-shaped bottom area and extend into the upper decorated wall is even smaller.

The above description is oriented at two axes, the axis of the spraying head and the axis of the can. An additional plane can be introduced as a reference plane extending perpendicularly with respect to said can axis, namely a plane on which the can stands after having been removed from the spraying arrangement. With respect to said plane, when two separate spraying axes and two separate spraying heads are used, the radially outer spraying head is oriented such that it is located above said plane, whereas the spraying head coating the inner bottom portion adopts a larger angle with respect to said plane and is located further axially below than said outer spraying arrangement. When using one single spraying head which is moved along a guided path, an outer end position at a limit corresponds to that of said outer spraying head, when two separate spraying heads are used (claim 3, claim 31).

The spraying head mentioned usually forms part of a modular spraying arrangement comprising several elements, a sink for a color supply, an angle control means and an actual spraying head (claim 6). Said spraying head can realize both, a three-dimensional spray beam in the form of a cone and a substantially two-dimensional spray beam as a plane-shaped spray beam extending at a spraying angle (claim 20, 21). A fluid coating is moved within said spraying angle, outside of said spraying angle practically no coating substance is moved by compressed air. The angle within which said coating is moved has a center axis (in both, said two-dimensional and said three-dimensional embodiment), said center axis having been defined as a spraying axis hereinabove.

During coating and during application, a can rotates about two offset axes (claim 27), at different speeds, each. This corresponds to an orbital movement of said can, said spraying head itself co-rotating about the axis of a slowly rotating supporting means, whereas said can is moved relatively to the spraying head and at a higher speed. Preferred speeds for said orbital movement are above 60 r.p.m and above 800 r.p.m, respectively, which speeds are the two rotating components of each orbitally moved can (claim 9). One speed, as a rotating speed or angle speed, relates to said slow rotary movement of said supporting means (claim 29). The second rotary movement relates to a higher speed of supporting heads which are components of said supporting means, but which support the cans by vacuum or magnetically during a time interval of coating and during an orbital movement thereof (claim 30).

Preferably, several cans are supported simultaneously in said slowly rotating supporting means, said cans being coated with a coating substance along a segment of the rotation angle of said supporting means. Said angle segment is at least 15° in relation to a circumference of said slowly rotating supporting means. When said supporting means rotates at double speed, said angle is doubled. At both said speeds, the container rotates about 1.5 to 3 times, particularly substantially 2.5 times. During a coating process, each can rotates less than 6 times about its own axis. This corresponds to an angle segment during effecting coating which is between 15° and 80° at maximum, said range including slow and rapid rotations of said supporting means. A range of between 40° and 80° is preferred for aqueous varnishes, a range of between 15° and 40° is preferred for varnishes containing solvents. During said time interval determined by said angle segment, a spray beam having a strictly limited dimension is directed onto a bottom area of a can either by two spraying heads or by one spraying head changing a position thereof during coating.

The end positions, i.e. the maximum angle and the minimum angle of a moved spraying head or the adjustment of two separate spraying heads is defined such that a complete coating of a can bottom is achieved, a controlled and uniform film weight of said coating on the can and a smallest possible “overspray” at the outer portion of said bottom area are obtained. A complete coating of the can bottom excludes that portions of the beverage can other than the can area defined above are coated with one of said arrangement (claim 27) and said methods (claim 1, claim 10). The invention therefore only relates to coating the bottom area of a can, and not to an additional or only partial coating of a wall portion of said beverage can. Whether said wall portion has been coated in another manner by previous processes with a decoration as mentioned above, is, however, not excluded from the invention, when in another, previous time interval a decoration is applied with another arrangement or another method, and when said bottom area of said can is to be coated subsequently and exclusively after finishing said decoration.

In other words, also the contact plane can serve as a comparative plane. One spraying direction starts above said plane, and one direction is located below said plane. When using a continuously changing spraying direction, several other directions are provided between said two end positions (claim 7). Oriented at an observation system provided on said spraying head, a can is rotated relatively with respect to said observation system during coating (claim 23); during said rotation, the axis of coating (spraying axis) passes more than once, particularly several times, over a circumferential line at least in said outer bottom portion of said bottom area.

When using the inventive methods and the inventive arrangement, respectively, colored varnishes can be used, serving for an additional differentiation of the products. An abandonment of colorless varnish for said bottom area is not connected therewith. Both, colorless varnish splashes being optically visible and colorless varnish splashes in the decorated portion optically affecting said decoration, in any case, the use of colorless and particularly colored varnish as coating shall be permitted, achieving an additional advantage of a considerable reduction of varnish for coating only the bottom areas of beverage cans, when using the present invention.

The invention is described in more detail and supplemented by embodiments.

FIG. 1 illustrates the general idea of supplying beverage cans through a supply inlet 4, supporting said cans in a supporting means 3 during rotation, during which rotation coating is effected, and transporting said cans out along an outlet means 6.

FIG. 2 illustrates a section through an axis 100 of a slowly rotating supporting means 3 according to FIG. 1, wherein at least two spraying arrangements 10,10′ comprising spraying heads 15,15′ are provided, according to the present embodiment, said spraying arrangements being within said sectional plane. According to FIG. 1, six spraying arrangements are provided, one spraying arrangement at each supporting position of said circular, disc-shaped supporting means 3, said supporting positions being uniformly distributed over a circumference of said supporting means.

FIG. 3 is a schematic illustration of a spraying arrangement 10 having a spraying head 15, said spraying arrangement effecting a relative movement with respect to a can axis 102, several spraying axes 104,104′ being indicated, said spraying axes showing two possible end positions of said spraying arrangement 10, while said spraying arrangement moves along alternatively illustrated guided paths c1, c2.

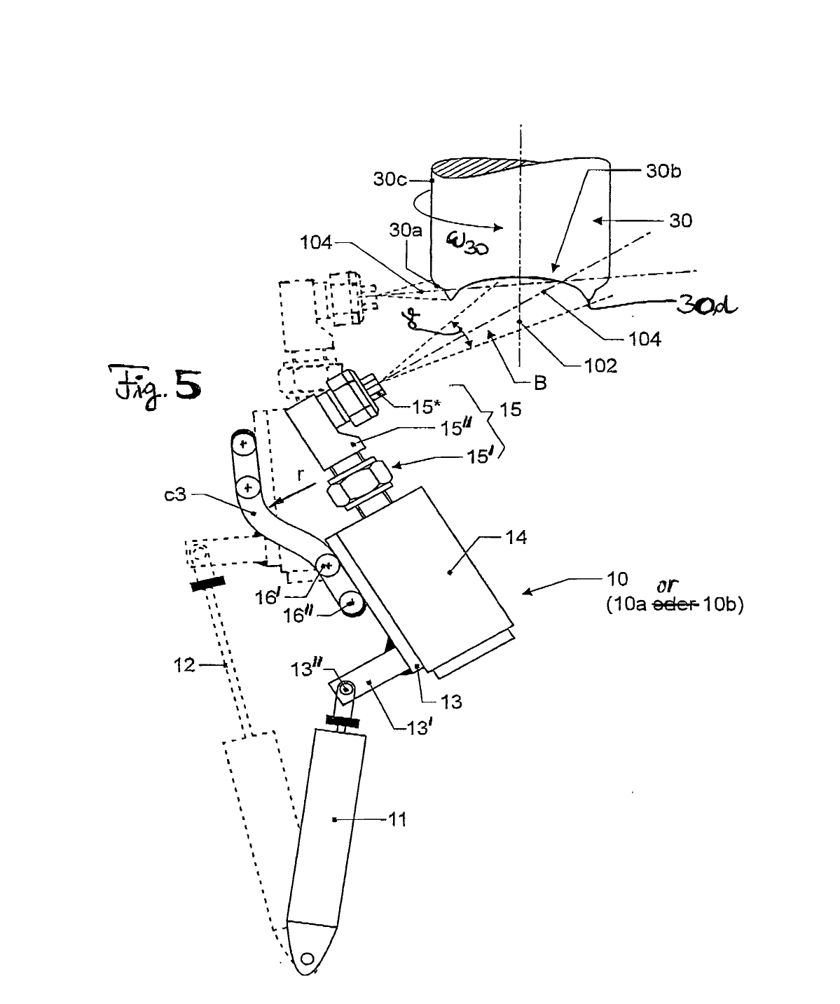

FIG. 4 illustrates an embodiment comprising two separate spraying heads 15a,15b at separate spraying arrangements 10,10′ said spraying arrangements coating different portions 30a,30b of a bottom area of said can 30 in a direction of two axes 104a,104b.

FIG. 5 illustrates an embodiment of a practical realization, comprising a path c3, wherein a spraying head 15 with an axis 104 thereof is oriented such that it coats a bottom portion 30b located further radially inward. The same spraying head is illustrated—by a broken-line illustration—in a moved or altered or changed position with respect to said first position, during coating a portion 30a located further radially outward of said bottom area, said portion at least partly forming part of a wall portion 30c or just adjoining said wall portion which is oriented in a vertically upward direction according to the present illustration.

FIG. 1 is an illustration of the surroundings of the invention. Cans 30 are supplied through an inlet basket into the can inlet of the machine. The cans are supplied to an inlet star 5 by their own weight and the dynamic pressure in said inlet basket, said inlet star having plate shape and being equipped with individual gripping portions. Said inlet star passes the cans to a continuously operating supporting or receiving plate 3 comprising six magnetically operating supporting means for said cans. Said supporting means 3a and 3b are shown in section in FIG. 2.

Said receiving plate 3 as a support for several circumferentially moved cans comprises an axis 100 which is shown in a sectional view in FIG. 2. Said receiving plate 3 rotates at a speed ω₃ (omega₃). Additionally, said cans 30 rotate at a speed ω₃₀ (omega₃₀), a much higher speed about their own axis 102, said axis being coincident with an axis 101 of magnetically operating supporting plates 3a,3b according to FIG. 2.

The cans 30 are subsequently supported at a rim on said magnetic plates 3a,3b such that they can rotate about said axis 102,101, during being orbitally rotated about said axis 100 by said support 3. Due to the rotation of said plate 3, the cans are moved past a drive belt 41, said drive belt rotating the respective magnetic plates which are visible in the left lower portion of FIG. 1. Said rotation ω₃₀ serves for coating the cans at a bottom area thereof. Said coating starts in FIG. 1 approximately at the 7 o'clock position (below on the left), a varnish being supplied according to FIG. 2 through a main shaft 2 of said supporting means 3, said main shaft being located in said axis 100 and schematically illustrated by a line 40 through which two spraying arrangements 10,10′ as illustrated, each comprising a spraying head 15,15′ are supplied. Said spraying heads co-rotate at the same speed at which said supporting means 3 is rotated, orienting themselves with respect to a respective can 30 such that a rotary movement thereof about said axis 101,102 is effected relatively to a respectively attributed spraying head 15. Therefore, FIG. 2 is only a detail of several symmetrically positioned spraying arrangements which have a modular structure and an identical technical design.

The actual coating process of said bottom area is described in more detail further below with reference to the additional figures, at this point it is still mentioned how said thin-wall cans 30 which are fixed in said supporting means 3 by magnetic force, leave said supporting means. In the 1 o'clock position, they are taken up by an outlet star 7 corresponding to said inlet star 5 and removed from said supporting means 3. Said removal movement corresponding like a mirror image to said inlet star transports said cans 3 into an outlet channel 6 supplying them to a further handling or treatment.

FIG. 1 further shows: a drive motor 42 for driving said circumferential drive belt 41 by which said magnetic plates 3a,3b (and additional magnetic plates not illustrated here) are rotated at said supporting means 3. The rotation of said supporting means 3 is effected by an additional motor with drive not illustrated here, by which a shaft 2 is rotated, said rotation being lower than the rotary movement of the cans. A suction means 20 which takes up varnish remainders of said bottom coating process from the left lower portion of said supporting means 3 and carries them off has a conventional design.

In FIG. 2, already two spraying arrangements 10,10′ are illustrated which co-rotate with said shaft 2 about said axis 100, said shaft being fixedly connected with said supporting means 3. Said co-rotation of said two spraying arrangements on said shaft 2 can be realized by fixedly mounting them at said shaft through correspondingly designed intermediate pieces having cone-shaped intermediate portions. A bottom area of a can 30 is illustrated in a lower portion of FIG. 2, whereas an upper portion of said figure only shows a magnetic support 3a without a can being attributed thereto, an axis 104 being marked instead, said axis illustrating the orientation of a spraying arrangement 10′ comprising a spraying head 15′. Said axis will be described more in detail hereinafter and is oriented towards said bottom area of said can 30, said bottom area according to the present embodiment comprising an edge portion 30a being directed towards a wall, and an inner central portion corresponding to a dome-shaped bottom portion 30b. The spraying heads 15,15′ are controlled according to FIGS. 3, 4 and 5.

According to FIG. 3, one single spraying head is provided, said spraying head being located at a spraying unit 10 which is illustrated schematically without a corresponding arrangement and inlet according to FIG. 2. FIG. 3 can be concretely designed according to the example of FIG. 5 which shall be described later. For the present, it is pointed out that a bottom area comprises two portions 30b (central portion) and 30a (edge portion directed towards a wall), whereas a wall portion 30c of said can 30 which extends in parallel with respect to said can axis 102 is oriented in parallel with respect to said axis 101 of said magnetic plate. A contact ring 30d of said can is located in a contact plane 103. Said contact ring is provided between said portions 30b and 30a.

A can rotates at an angle speed ω₃₀. The corresponding axes 104,104′ are oriented at said axis 104 of FIG. 2, as described above, said spraying axis 104 defining the center of a spraying angle γ (gamma).

Said axis 104 is marked at an angle α with respect to said axis 102 of said can body 30. Said spraying angle γ is oriented towards said edge portion of said bottom area. Said spraying head 15 is moved along a guided path for changing a direction from which said bottom area is coated with a fluid coating, particularly a colored varnish. A change of both, the position and the orientation of said axis 104 characterizes a different direction.

Said different direction can result from a different position, but it can also be provided by a different position of said axis 104. In the present embodiment, two alternative guided paths c1 and c2 are illustrated, said paths permitting a movement of said spraying head 15, actually a movement of the entire spraying unit 10. A path c1 is provided, said path being marked to extend at a radius r about the lower contact edge of said can 30, said path permitting a circular movement of said spraying head 15, starting at an angle (x and ending at a smaller angle β. Within said portion, said spraying axis 104 continuously changes during spray coating, thus coating the edge portion and the inner dome portion 30b of said bottom while said can 30 is continuously rotated. α can be somewhat larger than illustrated in FIG. 3, for example as large as shown in FIG. 4, here with respect to a spraying head 15a.

A second path c2 according to FIG. 3 is a straight path, which has a substantially straight extension at an angle δ (delta), said angle being in relation to said can axis 102. According to this embodiment, said different direction of spray-coating comprises a displacement of said axis 104 in the sense of a parallel displacement. A further—not illustrated—embodiment comprises an angle δ of zero and a displacement of said spraying axis in parallel with respect to said axis 102 in an only axially oriented direction. All embodiments described of changing the direction of color application can also be combined on the condition that the guided path of said spraying head is adapted correspondingly.

In FIG. 4, the application of varnish with two separate heads is described which are designated as spraying heads 15a and 15b. Each spraying head is a front end of a spraying unit 10a,10b and provides a different angle of coating γ₁,γ₂. One of said two spraying arrangements is located above a contact plane 103 and the other below said plane such that an inclination angle β with respect to an axis is smaller than an inclination angle α of a spraying unit 10a located above said plane 103 (with respect to an axial portion below said plane 103). The total of α+β as an intermediate angle is larger than 90°.

One of said spraying arrangements is positioned such that the application of the coating is effected from a direction which starts above said contact plane 103 of said beverage cans, for defining an angle larger than zero with respect to said plane or a mentioned total angle of larger than 90° between said two spraying units. When using only one spraying unit, which is movable as described in FIG. 3, an angle orientation of said spraying axis 104 at an outer end position may correspond to an angle orientation which is defined by said first spraying head 10a with an axis 104a thereof. An angle larger than 90° has to be regarded as a value without sign, said angle in a mathematically negative sense (clockwise) being larger than 90° in absolute value with respect to said axis. Said angle is directed from an axial portion 102 below said contact plane 103 towards said spraying axis 104a or towards said outer end position of said axis 104 of said moved spraying arrangement 10, respectively (sign).

A can 30 rotates at an angular speed ω₃₀, spray-coating with two spraying arrangements not being effected simultaneously, but offset in time. Initially, a radially outer portion 30a of said can can be coated with said spraying head 15a. Thereafter, said spraying head switches off and a varnish supply 40 according to FIG. 2 is connected to said spraying head 15b (spraying unit 10b), for coating said inner bottom portion 30b.

The sequence of coating can also be effected vice versa, the movement of said spraying head 15 in accordance with FIG. 3 also being possible from a lower inner end of said guided path c1, c2 in a radially outward and axially upward direction.

A concrete guided path c3 is illustrated in FIG. 5. In said illustration, also a reference axis 102 of said can 30 is visible, said can comprising a wall portion 30c, a contact portion as a radially outer bottom portion 30a, and an inner dome portion 30b. A spraying axis 104 is inclined with respect to said can axis 102. Said inclination is selected to correspond to said angle β of FIG. 3. When moving the illustrated spraying unit 10 along said guided path c3, the end of said movement corresponds to a position which is illustrated by a broken line, said axis 104 extending almost in parallel with respect to said plane 103 of FIG. 4. Preferably, said movement can also end somewhat further above, so that an angle α according to FIG. 4 is reached.

A spray beam B has a spraying angle γ as described hereinbefore.

Said guided path c3 shall be described in more detail which is realized by a cylinder 11 supported about a pivoting point. A pneumatic cylinder 11 provides for a movement of a spraying arrangement 10 between two illustrated end positions, for changing the direction of spray coating B. In said guided path c3, respectively two ball bearings 16′,16″ are provided which are connected with a plate 13 at which a basic part 14 of said spraying head 10 is arranged. An extension of said cylinder 11 by a piston 12 results in a change of the position of a coupling means 13″ which is connected through a web 13′ with said basic plate 13, at which also said ball bearings or guide rollers are located. An extended position of said cylinder 11 is illustrated by said broken-line illustration of FIG. 5, said ball bearings having reached an upper end of said guided path c3, an said axis 104 of said spraying head 15 being oriented substantially horizontally with respect to said contact plane 103 (compare FIG. 4).

For illustrating the radius r according to FIG. 3, said radius is also marked in FIG. 5. Said portion of said guided path is a substantially circular-arc movement of said spraying head 15 about said portion 30a of said bottom area of said can 30. In addition to said circular-arc path, a linear portion is provided at a lower end of said guided path c3, said linear portion enabling a displacement of said spraying head 15 similar to the guided path c2 of FIG. 3.

In FIG. 5, said spraying head 15 is illustrated in more detail, comprising a channel means 15′, an angular deviation means 15″ and an actual spraying head 15*, said components extending from a basic part 14 of said modular spraying unit. A main supply means of varnish is attributed to said spraying unit 10, said main supply being designated 40 in FIG. 2. Here is the starting point of said colored varnish supplied under pressure, for being applied onto a bottom area at a spraying angle γ in a direction of an axis 104.

Said man supply 40, which is integrated into said shaft 2, is separated into two arms 40a, 40b at a height of said spraying heads, as illustrated herein. When several spraying heads are provided, the number of arms corresponds thereto. When, in accordance with FIG. 4, two spraying heads are used for coating a bottom area of a can as illustrated below in FIG. 2, two branch lines 40b′, 40b″ extend towards said two spraying heads 10a, 10b. At said positions, two separate valves are provided permitting each spraying head to be activated individually, enabling an adjustment of their time control and determining the duration of coating. In each of said branch lines 40b′ and 40b″, flow measuring arrangements know from prior art, such as pressure pickups or flowmeters, are provided which are adapted to measure the flow of said fluid coating. When said coating by said two heads overlaps in time, a blockage, stoppage or any other malfunction of said two heads can thus be measured.

In FIG. 3, said angle α is illustrated somewhat too small, it is somewhat larger, up to a range which is shown in FIG. 4 for a spraying head 10a. Alternatively, a spray beam γ can be reduced, for remaining closer to said edge portion 30a of said bottom area.

1. Method for coating bottom areas (30a,30b) of cans (30) with a fluid coating substance, each of said cans (30) having a can axis (102); wherein
(a) said cans (30) are supplied consecutively from an inlet (4), for being supported on a supporting means (3) for at least a coating time interval and for being rotated about at least one axis (100,101,102);
(b) during said coating time interval and during rotation,
(aa) at least one of said supplied cans (30) is spray-coated with said coating by a spraying head (15,15a) having a spraying axis (104,104a), said spraying being effected at a first angle (α) of said spraying axis with respect to said can axis (102) onto an outer portion (30a) of said bottom area of said at least one can;
(bb) said coating is sprayed onto a further portion (30b) of said bottom area, said further portion being located (further) radially inward, said spraying being effected at a second angle (β) with respect to said can axis, said second angle (β) differing from said first angle (α).

2. Method according to claim 1, wherein said further inward located portion (30b) of said bottom area is coated by a second spraying head (15b), said second spraying head being positioned separate from said first spraying head (15a) and at a distance thereof, said two directions of angle (α, β) corresponding to said spraying axes (104a,104b) of said two spraying heads (15a,15b).

3. Method according to claim 1, wherein said two spraying axes (104a,104b) include an angle larger than 90° (α+β), particularly said angle (α) of said axis directing towards said outer portion having a size such that said spraying direction extends from above a contact plane (103) of said cans (30) for intersecting said outer portion of said bottom area of said can at an angle larger than zero with respect to said contact plane, respectively having an angle larger than 90° with respect to said can axis (102).

4. Method according to claim 1, wherein said two portions (30a,30b) of said bottom area are spray-coated by the same spraying head (15) which is moved from said first direction of angle (α) to said second direction of angle (β) while coating during rotating said can (30).

5. Method according to one of claims 1 and 4, wherein initially, said further inward located portion (30b) and then, said outer portion (30a) is coated, particularly spray-coated.

6. Method according to claim 4, wherein said spraying head (15) is a component of a modular spraying arrangement (10,14,15′,15″,15*), said spraying arrangement being movable along a guiding path (c1, c2, c3;16′,16″).

7. Method according to claim 4, wherein said two angles (α,β) are end positions of said spraying head, said end positions having between them a plurality of further orientations or directions of said spraying axes (104), all of said orientations or directions being oriented such that they direct towards said bottom area (30a,30b) or intersect said bottom area.

8. Method according to claim 2, wherein said two spraying axes extend in a plane, particularly having an angle of larger than 90° between them.

9. Method according to claim 1, wherein said supporting means receives a plurality of cans at a radial distance with respect to an axis (100) thereof and also at a circumferential distance, for rotating said cans to effect an orbital movement about said supporting means axis (100), said movement particularly comprising two rotating components (ω₃,ω₃₀) having a speed of more 60 r.p.m. and of more 800 r.p.m., respectively.

10. Method for a coating of bottom areas (30a,30b) of cans (30), each can (30) having a can axis (102) and each bottom area comprising an inner portion (30b) and an outer portion (30a), said outer portion being located further radially outward and extending at least partly adjacent to a can wall (30c); wherein
(a) said cans (30) are supplied consecutively from a supply inlet (4), for being supported on a supporting means (3) for at least a coating interval and for rotating about at least one axis (100,101,102);
(b) during said coating interval and during said rotation (ω₃,ω₃₀),
(aa) a coating is sprayed onto said outer portion (30a) of said bottom area of one of said cans (30) by a spraying head (15,15a) having a corresponding spraying axis (104,104a), said spraying being effected at a first angle (α) of said spraying axis with respect to said can axis (102);
(bb) said coating is sprayed onto said portion (30b) of said bottom area being located further radially inward, said spraying being effected from at least one other direction (104b,β,c1, c2), differing from said first spraying direction of said coating.

11. Method according to one of claims 1 and 10, wherein a varnish or lacquer is used for said coating—said varnish or lacquer containing a coloring substance.

12. Method according to claim 10, wherein said other direction is a direction substantially offset in parallel with respect to said axial direction (102) of said at least one can (30).

13. Method according to one of claims 12 and 10, wherein said other direction is another inclination (β) of said spraying axis (104b) with respect to said at least one can axis (102).

14. Method according to one of claims 10, 12 and 13, wherein said other direction results from another radial distance of said spraying head (15) with respect to a can axis (102) of a can allocated to said spraying head, particularly a spraying angle (γ), within which said coating is moved due to a spraying effect, remaining unchanged.

15. Method according to claim 10, said other direction results from a guided path (c1, c2, c3) of said spraying head (15), particularly as a sequence of many other directions, said spraying head (15) moving along said curved guided path (c1, c2, c3) during spraying.

16. Method according to claim 15, wherein said movement is a continuous movement, and said spraying axis (104) continuously changes in direction.

17. Method according to one of claims 15 and 16, wherein said path is inclined at an angle (δ) with respect to said can axis (102), particularly having at least one of a curved and a linear extension (c1, c2, c3) along a portion thereof.

18. Method according to claim 17, wherein said curved path substantially extends along an arc segment of a circle having a path radius (r), said arc segment being oriented about a center, said center being located close to said outer portion (30a) of said bottom area of said at least one can.

19. Method according to claim 1, wherein said first angle (α) with respect to said can axis (102) is larger in absolute value than said second angle (β).

20. Method according to one of the aforementioned claims, wherein said spraying head (15) applies a cone-shaped spray beam of said coating substance during coating said bottom area, said spray beam having a spraying angle (γ) within which said coating substance is moved.

21. Method according to claim 20, wherein said spray beam has a spraying angle (γ) of substantially less than 30°, particularly of less than 20°.

22. Method according to one of the aforementioned claims, wherein each of said cans (30) is rotated about two offset axes (100,101), said first axis (100) being an axis of a rotating supporting means (3) and said second axis (101) being an axis of a supporting head (3a,3b) by which each can is positioned at a distance of said first axis (100) of said supporting means, for effecting an orbital movement of several cans on said rotating supporting means.

23. Method according to one of the aforementioned claims, wherein during a coating interval and during rotation, at least one spraying head is attributed to one can, respectively, such that said can and said spraying head rotate in opposite directions with respect to each other, particularly such that out of an observation system of said spraying head (15,15a), said can (30) attributed to said spraying head is rotated such (ω₃₀) that said spraying axis (104,104a) of said spraying head passes more than once over a circumferential line of said bottom area.

24. Method according to claim 2, wherein said two spraying heads (15a,15b) apply said coating onto said bottom area (30a,30b), said application being offset in time, particularly alternately.

25. Method according to claim 2, wherein one flow recognition means, respectively, is provided for a flow of said fluid coating to one of said two spraying heads (15a,5b), respectively, said flow recognition means particularly being attributed to one of a respective spraying means according to claim 6 and a supply means (40a,40b) to said respective spraying head (15a,15b), for recording a reduced flow, while said two spraying heads operate simultaneously during a time interval.

26. Method according to one of claims 1 and 10, wherein said cans (30) are thin-wall beverage cans, comprising bottom areas being dome-shaped towards an inside thereof, and a circumferential contact ring protruding in an axial direction with respect to said dome-shape.

27. Arrangement for carrying out the methods according to one of claim 1, claim 2 and claim 10 for partly spray-coating at least one can (30) as a substantially cylindrical object, during rotating said can about a can axis (102) thereof, said arrangement comprising a rotatable support (3; 3a,3b) rotating said at least one can to effect an orbital movement about an axis (100) of said support, and wherein
(a) at least one spraying unit (15,10) being provided, said spraying unit comprising a spraying head and having an axis (104; 104a,104b) of said spraying head (15*), said spraying head being inclined with respect to said can axis, said spraying unit being rotatable about said axis (100) of said support (3) together with the rotation of said support (3), characterized in that one of
(b1) said spraying unit being movable along a path (c3, c2, c1) for changing a position and the axis (104) thereof during spraying; and
(b2) two spraying units, not being movable to change positions thereof nor spraying axes (104,104b) thereof, being allocated to one of said same can (30) and a supporting means (30a,30b) for said can, such that said two spraying axes do not coincide, but are both oriented onto said bottom area (30a,30b) of said can (30).

28. Arrangement according to claim 27, being constructionally embodied according to one of claims 1 to 25.

29. Arrangement according to claim 27, wherein said rotatable supporting means (3; 3a,3b) allowing a rotation at a speed (ω₃), said speed having a rotation component of more than 60 r.p.m, particularly of between 60 and 150 r.p.m.

30. Arrangement according to one of claims 27 and 29, wherein said supporting means (3; 3a,3b) comprising several supporting heads (3a,3b) distributed over a circumference thereof, said supporting heads being located at a radial distance from an axis (100) of said supporting means for receiving said cans, for moving said cans at a speed (ω₃₀), said speed having a rotation component of more than 800 r.p.m., particularly between 800 and 2000 r.p.m.

31. Arrangement according to claim 27, wherein at least two directions of angle (α,β) being provided, said directions being predetermined by one single spraying unit (15,10) or by two separate spraying units, and one of said directions (α) with respect to said can axis being oriented such that an angle of less than −90° measured clockwise (in a mathematically negative sense) is included between said direction and said can axis, or said angle is larger than 90° in absolute value.
